(19) United States
(12) Patent Application Publication
(10) Pub. No.: US 2025/0225336 A1
(43) Pub. Date: Jul. 10, 2025

(54) COMPUTER-IMPLEMENTED METHODS, SYSTEMS COMPRISING COMPUTER-READABLE MEDIA, AND ELECTRONIC DEVICES FOR FEED-FORWARD, FEED-BACKWARD ENTITY STANDARDIZATION

(71) Applicant: Mastercard International Incorporated, Purchase, NY (US)

(72) Inventors: Justin Harnish, Salt Lake City, UT (US); Nick Baguley, Salt Lake City, UT (US); Vivek Salvi, Dombivli (IN); Wesley Smith, Sandy, UT (US)

(73) Assignee: Mastercard International Incorporated, Purchase, NY (US)

(21) Appl. No.: 18/406,833

(22) Filed: Jan. 8, 2024

(51) Int. Cl. G06F 40/40; G06F 16/383; G06Q 20/20

(52) U.S. Cl. CPC G06F 40/40; G06F 16/383; G06Q 20/209

(57) ABSTRACT

Computer-implemented method for entity standardization that includes: inputting unstructured transaction data corresponding to a financial transaction to a natural language processor (NLP) to generate NLP output comprising a portion of the unstructured transaction data; inputting the NLP output to an entity service; inputting entity feedback data to the entity service; based on the NLP output and the entity feedback data, generating a probabilistic confidence indicator via the entity service, the probabilistic confidence indicator meeting or exceeding a threshold for standardized matching of an entity to the financial transaction; and, based on the probabilistic confidence indicator (i) associating the entity with one or more of the financial transaction and the NLP output in an entity identification database, and (ii) configuring a lookup table to deterministically identify the entity in connection with a second financial transaction based on the NLP output.

### RELATED APPLICATIONS

The current patent application is filed contemporaneously with identically-titled U.S. Patent Application zz/xxx,xxx; U.S. Patent Application zz/xxx,xxx; and U.S. Patent Application zz/xxx,xxx, and the entire disclosure of each of the foregoing applications is hereby incorporated by reference herein.

### FIELD OF THE INVENTION

The present disclosure generally relates to computer-implemented methods, systems comprising computer-readable media, and electronic devices for entity standardization. More particularly, the present disclosure generally relates to unnatural language processing relying on feed-forward and feed-backward processes for entity standardization in connection with financial transactions.

### BACKGROUND

The use of raw and often unstructured data (especially free-text description and memo fields) from banking transactions as a data source for identifying involved entities (i.e., participants in the transactions, such as individuals or juridical entities) is difficult. Such raw transaction information is unlike natural language because grammar and syntax clues are significantly reduced or non-existent, and unnecessary or unrelated information (e.g., alphanumeric information) is often included, at times mid-string. Strings that may be related to entity identification may be disrupted, incomplete, unpredictably altered, truncated or the like, e.g., where such a string is encoded by wildcard (*) truncations, is misspelled, is split, is intermingled with seemingly unrelated alphanumeric characters, or is simply partly or entirely omitted.

Components traditionally utilized in natural language processing have low accuracy in resolving entities from such data—e.g., from the combined description and memo fields—because of reduced consistency in syntax. Such existing natural language processors (NLPs) are limited to normalizing a low proportion of proper nouns to a resolution of the entity, which in any event is a lower standard than a preferred goal of entity standardization for downstream computer identification of the entities for data lookups, classification, and subsequent analytics.

What is needed, then, for processing such raw banking transaction strings is a separate and unique domain of data science and data engineering.

This background discussion is intended to provide information related to the present invention which is not necessarily prior art.

### BRIEF SUMMARY

Embodiments of the present technology relate to computer-implemented methods, systems comprising computer-readable media, and electronic devices for entity standardization. The embodiments may include contributions not only from feed-forward data from financial institutions, but also from feed-backward sources of information. These feed-backward sources may be intellectual property data sources that have standardized entity names tied to other valuable sources of data on merchants, may comprise a component of data streams that cross-check non-string data for consistency over time and value amount, and/or may include user transaction edits, behavioral sentiment socialization, and/or the like, in each case for supporting entity standardization and correction.

More particularly, in a first aspect, a computer-implemented method for entity standardization may be provided. The method includes: inputting unstructured transaction data corresponding to a financial transaction to a natural language processor (NLP) to generate NLP output comprising a portion of the unstructured transaction data; inputting the NLP output to an entity service; inputting a recurring transaction indicator to the entity service; based on the NLP output and the recurring transaction indicator, generating a probabilistic confidence indicator via the entity service, the probabilistic confidence indicator meeting or exceeding a threshold for standardized matching of an entity to the financial transaction; and, based on the probabilistic confidence indicator, associating the entity with one or more of the financial transaction and the NLP output in an entity identification database. The method may include additional, less, or alternate actions, including those discussed elsewhere herein.

In a second aspect, another computer-implemented method for entity standardization may be provided. The method includes: inputting unstructured transaction data corresponding to a financial transaction to a natural language processor (NLP) to generate NLP output comprising a portion of the unstructured transaction data; based on the NLP output, generating a probabilistic confidence indicator via an entity service, the probabilistic confidence indicator matching an entity to the financial transaction; receiving input from the account holder relating the entity to one or both of the NLP output and the financial transaction; and, based on the input from the account holder, associating the entity with one or both of the financial transaction and the NLP output in an entity identification database. The method may include additional, less, or alternate actions, including those discussed elsewhere herein.

In a third aspect, yet another computer-implemented method for entity standardization may be provided. The method includes: inputting unstructured transaction data corresponding to a financial transaction to a natural language processor (NLP) to generate NLP output comprising a portion of the unstructured transaction data; inputting the NLP output to an entity service; inputting merchant metadata for a plurality of merchants to the entity service; based on the NLP output and the merchant metadata, generating a probabilistic confidence indicator via the entity service, the probabilistic confidence indicator meeting or exceeding a threshold for standardized matching of a merchant of the plurality of merchants to the financial transaction; and, based on the probabilistic confidence indicator, associating the matched merchant with one or more of the financial transaction and the NLP output in an entity identification database. The method may include additional, less, or alternate actions, including those discussed elsewhere herein.

In a fourth aspect, still yet another computer-implemented method for entity standardization may be provided. The method includes: inputting unstructured transaction data corresponding to a financial transaction to a natural language processor (NLP) to generate NLP output comprising a portion of the unstructured transaction data; inputting the NLP output to an entity service; inputting entity feedback data to the entity service; based on the NLP output and the entity feedback data, generating a probabilistic confidence indicator via the entity service, the probabilistic confidence indicator meeting or exceeding a threshold for standardized matching of an entity to the financial transaction; and, based on the probabilistic confidence indicator (i) associating the entity with one or more of the financial transaction and the NLP output in an entity identification database, and (ii) configuring a lookup table to deterministically identify the entity in connection with a second financial transaction based on the NLP output. The method may include additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

FIG. 1 illustrates various components, in block schematic form, of an exemplary system for entity standardization in accordance with embodiments of the present invention;

FIGS. 2 and 3 respectively illustrate various components of an exemplary computing device and server shown in block schematic form that may be used with the system of FIG. 1;

FIG. 4 is a flowchart of various logical components of, and information flows between, one or more of the exemplary devices and network(s) for entity standardization of FIGS. 1-3;

FIG. 5 is a flowchart illustrating at least a portion of the steps for entity standardization in accordance with embodiments of the present invention;

FIG. 6 is a flowchart illustrating at least a portion of the steps for entity standardization in accordance with embodiments of the present invention;

FIG. 7 is a flowchart illustrating at least a portion of the steps for entity standardization in accordance with embodiments of the present invention, and

FIG. 8 is a flowchart illustrating at least a portion of the steps for entity standardization in accordance with embodiments of the present invention.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for natural language processing to resolve entities from memo and other unstructured financial transaction data fields are insufficient. Embodiments of the present invention utilize unnatural language processing and feed-backward mechanisms with a probabilistic entity service for entity standardization, thereby providing a separate and unique domain of data science and data engineering solving the technical problems inherent in such unstructured data.

### Exemplary System

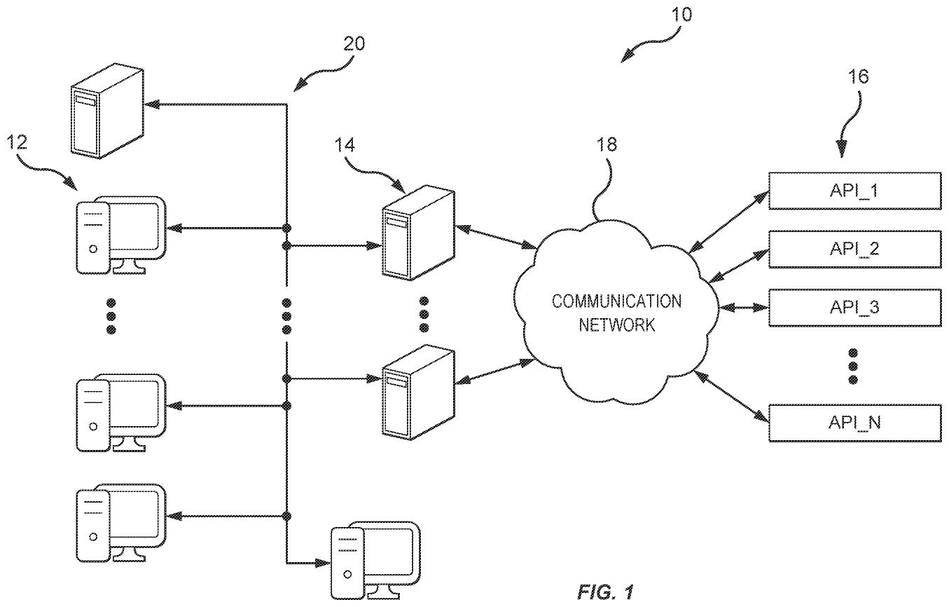

FIG. 1 depicts an exemplary environment 10 for entity standardization according to embodiments of the present invention. The environment 10 may include a plurality of computers 12, a plurality of servers 14, a plurality of application programming interfaces (APIs) 16, and communication networks 18, 20.

The servers 14 may be located within network boundaries of a large organization, such as a corporation, a government office, or the like. In one or more embodiments, the organization may be a financial service provider providing an open banking platform or the like to account holders or consumers. The account holders may operate the computers 12. Accordingly, the communication network 18, computers 12 and/or the APIs 16 may be external to the organization operating the servers 14, for example where the APIs 16 are offered by financial institutions—such as payment processing network(s), card issuer(s) and/or other banking institutions, merchant(s) and the like—in each case making financial transaction, merchant and/or account holder data and metadata available for analysis, as discussed in more detail below.

The servers 14 may manage access to financial transaction, merchant and/or account holder data and metadata, to output of the servers 14, and/or to the APIs 16, under a common authentication management framework in accordance with embodiments of the present invention. Each user of a device 12 may be required to complete an authentication process—e.g., an open banking platform access authentication process—to access corresponding portions of such data via the servers 14. Likewise, APIs 16 may exchange data with the servers 14 and/or with the computers 12 (e.g., where computers 12 provide data directly to the APIs 16 for transmission to the servers 14) using an authentication process. For instance, the common authentication management framework may comprise one or more servers made available under WebSEAL® (a registered trademark of International Business Machines Corporation) as of the date of initial filing of the present disclosure.

It should also be appreciated that tokenized access protocols may be implemented—for example, between servers 14 and APIs 16—in connection with data exchanges according to embodiments of the present invention. Moreover, all or some of the APIs 16 may be maintained and/or owned by the organization providing an open-banking platform and/or an affiliated organization, and/or may be maintained on the network 20, within the scope of the present invention. One of ordinary skill will appreciate that the servers 14 may be free of, and/or subject to different protocol(s) of, the common authentication management framework within the scope of the present invention.

Data made available via the APIs 16 and/or computers 12 may comprise feed-backward data consumed by an entity service discussed in more detail below for entity standardization in connection with financial transactions of account holders. Further, the servers 14 may be maintained by a financial service company providing an open banking platform, and authenticated account holders may access an exemplary system implemented on the servers 14 to manage payments, gain insight into spending trends and recommendations, manage finances and otherwise direct customary open banking functions. An employee of the financial service company or organization may also access such an exemplary system from a computer 12 to query the APIs 16, generate and/or use the data platform's data.

One of ordinary skill will appreciate that embodiments may serve a wide variety of organizations and/or rely on a wide variety of datasources within the scope of the present invention. For example, one or more datasources accessed by a system according to embodiments of the present invention may be available to the public. Moreover, one of ordinary skill will appreciate that different combinations of one or more computing devices—including a single computing device or server—may implement embodiments without departing from the spirit of the present invention.

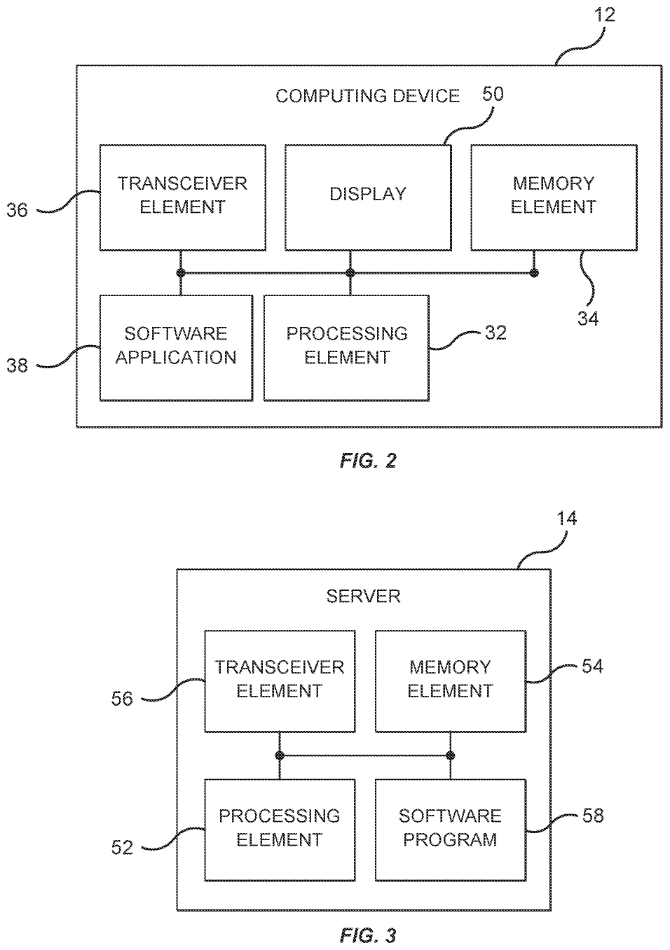

The computers 12 may be workstations and/or personal/individual devices. Turning to FIG. 2, generally the computers 12 may include tablet computers, laptop computers, desktop computers, workstation computers, smart phones, smart watches, and the like. In addition, the computers 12 may include copiers, printers, routers and any other device that can connect to the network 20, the servers 14, the APIs 16 and/or the communication network 18. Each computer 12 may include a processing element 32 and a memory element 34. Each computer 12 may also include circuitry capable of wired and/or wireless communication with the internal network 20 and/or the communication network 18, including, for example, transceiver elements 36. Further, the computers 12 may respectively include a software application 38 configured with instructions for performing and/or enabling performance of at least some of the steps set forth herein. In one or more embodiments, the software applications 38 comprise programs stored on computer-readable media of memory elements 34. Still further, the computers 12 may respectively include a display 50.

Generally, the servers 14 implement a platform for managing receipt, storage, and analysis of financial and/or financial institution or transaction data, providing open banking platform services, and for generating output including entity identification(s) following resolution and/or standardization processes discussed herein. The servers 14 may retain electronic data, analyze data and may respond to requests to retrieve data as well as to store data. The servers 14 may comprise domain controllers, application servers, database servers, file servers, mail servers, catalog servers, or the like, or combinations thereof. In one or more embodiments, one or more APIs 16 may be maintained by one or more of the servers 14, including for data exchanges with other of the APIs 16. Generally, each server 14 may include a processing element 52, a memory element 54, a transceiver element 56, and a software program 58.

Each API 16 may include and/or provide access to one or more pages or sets of data and/or other content accessed through the World Wide Web (e.g., through the communication network 18) and/or through the network 20. Each API 16 may be hosted by or stored on a web server and/or database server, for example. The APIs 16 may include top-level domains such as “.com,” “.org,” “.gov,” and so forth. The APIs 16 may be accessed using software such as a web browser, through execution of one or more script(s) for obtaining provider data, and/or by other means for interacting with APIs 16 without departing from the spirit of the present invention. Each API 16 may be hosted and/or managed by a server constructed and operated, for example, in the manner described in connection with servers 14 herein.

The communication networks 18, 20 generally allow communication between the servers 14 of the organization, external APIs such as provider APIs 16, and/or computers 12, for example in conjunction with the common authentication framework discussed above and/or via secure transmission protocol(s).

The networks 18, 20 may include the Internet, cellular communication networks, local area networks, metro area networks, wide area networks, cloud networks, plain old telephone service (POTS) networks, and the like, or combinations thereof. The networks 18, 20 may be wired, wireless, or combinations thereof and may include components such as modems, gateways, switches, routers, hubs, access points, repeaters, towers, and the like. The computers 12, servers 14 and/or APIs 16 may, for example, connect to the networks 18, 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The transceiver elements 36, 56 generally allow communication between the computers 12, the servers 14, the networks 18, 20, and/or the APIs 16. The transceiver elements 36, 56 may include signal or data transmitting and receiving circuits, such as antennas, amplifiers, filters, mixers, oscillators, digital signal processors (DSPs), and the like. The transceiver elements 36, 56 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the transceiver elements 36, 56 may utilize communication standards such as ANT, ANT+, Bluetooth™ low energy (BLE), the industrial, scientific, and medical (ISM) band at 2.4 gigahertz (GHz), or the like. Alternatively, or in addition, the transceiver elements 36, 56 may establish communication through connectors or couplers that receive metal conductor wires or cables, like Cat 6 or coax cable, which are compatible with networking technologies such as ethernet. In certain embodiments, the transceiver elements 36, 56 may also couple with optical fiber cables. The transceiver elements 36, 56 may respectively be in communication with the processing elements 32, 52 and/or the memory elements 34, 54.

The memory elements 34, 54 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 34, 54 may be embedded in, or packaged in the same package as, the processing elements 32, 52. The memory elements 34, 54 may include, or may constitute, a non-transitory “computer-readable medium.” The memory elements 34, 54 may store the instructions, code, code segments, software, firmware, programs, applications, apps, services, daemons, or the like that are executed by the processing elements 32, 52. In one or more embodiments, the memory elements 34, 54 respectively store the software applications/program 38, 58. The memory elements 34, 54 may also store settings, data, documents, sound files, photographs, movies, images, databases, and the like.

The processing elements 32, 52 may include electronic hardware components such as processors. The processing elements 32, 52 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 32, 52 may include digital processing unit(s). The processing elements 32, 52 may generally execute, process, or run instructions, code, code segments, software, firmware, programs, applications, apps, processes, services, daemons, or the like. For instance, the processing elements 32, 52 may respectively execute the software applications/program 38, 58. The processing elements 32, 52 may also include hardware components such as finite-state machines, sequential and combinational logic, and other electronic circuits that can perform the functions necessary for the operation of the current invention. The processing elements 32, 52 may be in communication with the other electronic components through serial or parallel links that include universal busses, address busses, data busses, control lines, and the like.

Returning to FIG. 1, the servers 14 may manage queries to, and responsive financial institution, account holder and/or merchant data received from, APIs 16, and perform related analytical functions (e.g., as requested by one or more of the computing devices 12 and/or automatically as part of data intake and storage processes) in accordance with the description set forth herein. In one or more embodiments, the data may be acquired by other means, and the steps for analysis laid out herein may be requested and/or performed by different computing devices (or by a single computing device), without departing from the spirit of the present invention.

The data may be stored in databases managed by the servers 14 utilizing any of a variety of formats and structures within the scope of the invention. For instance, relational databases and/or object-oriented databases may embody such databases. Similarly, the APIs 16 and/or databases may utilize a variety of formats and structures within the scope of the invention, such as Simple Object Access Protocol (SOAP), Remote Procedure Call (RPC), and/or Representational State Transfer (REST) types. One of ordinary skill will appreciate that—while examples presented herein may discuss specific types of databases—a wide variety may be used alone or in combination within the scope of the present invention.

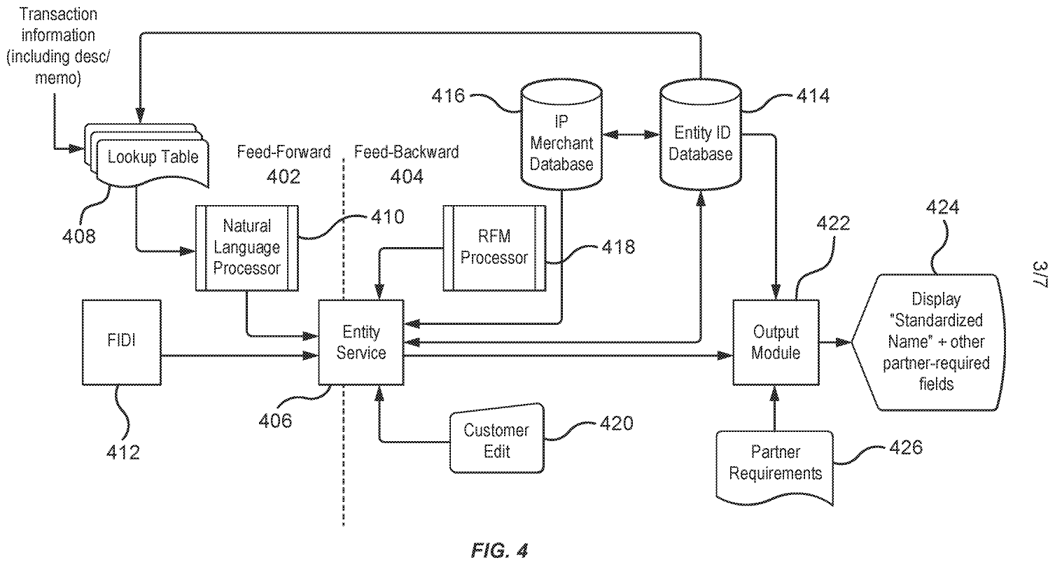

Turning now to FIG. 4, an exemplary flowchart illustrating logical components and data exchanges and flows is provided in accordance with embodiments of the present invention. Aspects of the exemplary system of FIG. 4 are conceptually divided into feed-forward 402 and feed-backward 404 mechanisms and components for clarity of discussion. More particularly, feed-forward 402 and feed-backward 404 components generally input data to entity service 406 for probabilistic analysis and entity standardization, as described in more detail below.

The feed-forward 402 components provide data that is derived from or describes a financial transaction (and corresponding transaction records) directly or indirectly to the entity service 406. The feed-forward 402 components include a lookup table 408, a natural language processor 410, and one or more financial institution direct integrations (FIDI) 412. The lookup table 408 may receive unstructured financial transaction data—such as that contained in a free-text description and/or memo field of a record of the transaction—and may parse, search and/or analyze same for one or more strings which exactly or approximately match token mappings to standardized entities. For example, the lookup table 408 may intermittently, continuously, and/or periodically receive token mappings from an entity identification (ID) database 414.

The entity ID database 414 may be the repository for confirmed, standardized entities and their associated strings, substrings, unique identifiers, combinations of any of the foregoing, and the like. In one or more embodiments, the entity ID database 414 will include records for each uniquely identified (e.g., standardized) entity—such as, for example, each merchant and account holder and/or account—and will define strings and substrings which, if found alone and/or in specified combination(s) and/or contexts in financial transaction data, positively identify, authenticate, and match to the standardized entity. For example, the entity ID database 414 may store a string combination defining conditions for identification of a grocery store having a unique merchant identifier within unstructured memo data for a financial transaction. The token mapping comprising a merchant string definition may match the merchant to the memo field if a specified combination of letters comprising a portion of the merchant's name appears within a pre-defined number of characters of a matching zip code. Accordingly, the entity ID database 414 may store authoritative token mappings, unique identifiers, strings, and substrings for standardized identification of entities involved in financial transactions, and may provide such data to the lookup table 408 and/or entity service 406.

It should also be noted that the standardized identified entities may nonetheless be susceptible to finer levels of resolution. For example, some groups of entities may operate a shared or pooled financial account and/or may share a business or corporate name, such as where a franchise exists. Accordingly, one level of standardized identified entity may comprise the shared aspect(s) and/or commonly-held franchise name, whereas a finer level of resolution may name each store or franchisee more specifically. Each level of standardized identification may be present in the entity ID database 414—and, more broadly, may be incorporated into standardization processes described herein—within the scope of the present invention.

The lookup table 408 may deterministically match the token mappings provided by the entity ID database 414 to one or more strings parsed from or identified in the unstructured data for the financial transaction. For example, the deterministic lookups performed by the lookup table 408 may utilize search algorithm(s) implementing names, partial names, and/or identifiers such as phone numbers or address information. The algorithm(s) may search forward and in reverse, may filter by additional transaction data such as value amounts and/or transaction type(s) (e.g., credit vs. debit), and utilize other search techniques to identify strings that are matches or near matches to strings represented in existing token mapping(s). The lookup table 408 may, for example, have a JavaScript Object Notation (JSON) formatting and may comprise keywords, aliases, full names for entities, algorithms for searches for substrings, multiple keywords located anywhere in unstructured text data (e.g., not just in a string of certain length), and/or may perform filtering operations. In one or more embodiments, a combination of keywords found in the text data combined with satisfaction of certain accompanying rules may generate a positively matched entity (e.g., where certain strings are not found, one or more defined keywords may suffice, and/or where a transaction amount exceeds a pre-defined threshold, one or more pre-defined keywords suffice, etc.).

In one or more embodiments, deterministic matching may be achieved using pattern and/or string matching, and/or distance metrics. More particularly, in one or more embodiments, the lookup table 408 may implement a distance metric (e.g., a ranked tree) to match a plurality of entities (e.g., merchants) represented in the entity ID database 414. The output of the distance metric analysis may satisfy a threshold for standardized identification of one of the plurality of entities. The successful standardized identification of the entity may obviate the need for probabilistic analyses and/or computations by the entity service 406 and/or may support labeled training of the entity service 406, lookup table 408, and/or NLP 410.

However, in one or more embodiments, the lookup table 408 operations will not result in a standardized identification of an entity in connection with the financial transaction, for example where the threshold for same is not reached. The lookup table 408 output may nonetheless be fed forward to the NLP 410 and/or entity service 406 for use in probabilistic entity standardization operations discussed in more detail below. Accordingly, in one or more embodiments, the string(s), distance metric(s), or the like extracted, parsed, analyzed, and/or implemented by the lookup table and/or resulting output may be insufficient for standardized identification of an entity, but may nonetheless inform probabilistic analyses performed by the entity service 406.

The NLP 410 may receive input comprising such output from the lookup table 408 and/or the raw unstructured (e.g., memo field) transaction data itself. The NLP 410 may comprise deep learning model(s), such as a named entity recognition (NER) model and/or a masked language model (MLM). Despite the low syntax, unstructured nature of the transaction data and output from the lookup table 408, the NLP 410 detects sentence and/or fragment boundaries, character usage, punctuation, and/or nonce characters, identifies word usage, choices, and relative position patterns, and otherwise maps the unstructured transaction data and/or output from the lookup table 408 according to pre-established conventions to extract strings and combinations of strings which may be used to identify one or more entities involved in the financial transaction. It should also be noted that the data and information extracted from the unstructured transaction data by the NLP 410 may undergo additional processing—e.g., normalization, correcting for missing letters and/or misspellings, or the like—within the scope of the present invention and prior to input into the entity service 406. In one or more embodiments, the NLP 410 may perform one or more of sentence segmentation, word tokenization, stemming, lemmatization, stop word analysis, dependency parsing, and/or part-of-speech tagging to produce output to the entity service 406.

The FIDI 412 may provide data to the entity service 406 that relates to the financial transaction and that is curated, delineated, generated, and/or passed along via an involved financial institution. For example, an acquirer involved in processing the financial transaction may provide data to the entity service 406 via the FIDI 412. The FIDI 412 data may include metadata regarding associated merchant(s), date/time information, extracted strings potentially identifying the entity and/or account, and/or other labeled data about and/or conveying attributes of the financial transaction that enrich and/or supplement the other feed-forward inputs to the entity service 406 discussed herein. The FIDI 412 data may support probabilistic operations of the entity service 406 for standardized entity identification.

In turn, the feed-backward 404 components provide data and/or analysis output regarding reaction(s) to transaction data and/or initial output(s) from feed-forward components 402, data relating to entity attribute(s), and/or historical transaction data, directly or indirectly to the entity service 406. The feed-backward 404 components include a merchant database 416 (which may comprise intellectual property (IP) of one or more financial service provider(s) and/or financial institution(s)), a recency, frequency, and monetary value (RFM) processor 418, and a customer edit or input module 420.

The merchant database 416 may be an internal or external database managed by a financial institution and/or financial service provider. The database 416 may be populated with historical data collected in connection with payment processing and/or collected from merchants and/or acquirers directly. The data in the merchant database 416 may describe historical transaction trends or behaviors of respective merchants represented and identified therein (e.g., identified according to unique identifiers also used in the entity ID database 414). The data in the merchant database 416 may also or alternatively describe attributes of such merchants (e.g., size, merchant category, category codes, firmographic data, and/or the like).

As noted here, the merchant database 416 may include historical transaction records and/or include descriptions or metrics relating to historical transaction behaviors of the merchants. Accordingly, embodiments of the present invention may include pre-computing historical transaction records associated with the plurality of merchants represented in the merchant database 416 to derive and store values relating to, reflecting and/or summarizing, or averaging/summing such behaviors. In each case, the data of the merchant database 416 may be inputted to the entity service 406 to support probabilistic operations of the entity service 406 for standardized entity identification.

The RFM processor 418 may check for and/or generate recurring transaction indicator(s) for the financial transaction. In one or more embodiments, a record associated with the financial transaction will be parsed or reviewed by the RFM processor 418 to locate a value populating a data field assigned for use with transactions under installment payment plans by a standardized financial transaction format.

For example, the International Organization for Standardization (ISO) specifies certain data fields for exchange in financial transactions. ISO 8583 specifies message structure, format and content, data elements, and values for data elements comprising a common interface by which financial transaction card-originated messages can be interchanged. While certain transaction data elements may be considered optional and others required under common implementations of ISO 8583, depending on the processing entity (ies) and/or regions in question for example, such variances are well understood by a person of ordinary skill. In this regard, the following generally known standards for completing financial transactions are hereby incorporated by reference: ISO 8583 Part 1: Messages, data elements and code values (2003); ISO 8583 Part 2: Application and registration procedures for Institution Identification Codes (IIC) (1998); and ISO 8583 Part 3: Maintenance procedures for messages, data elements and code values (2003)). The fields defined by ISO standards (e.g., 8583 and 18245) may include: primary account number (Field 2); transaction type (Field 3); amount transaction (Field 4); transmission date and time (Field 7); retrieval reference number (Field 37); response code (Field 39); card acceptor name/location (Field 43); personal identification number (Field 52); merchant type (Field 18); and installment information (Field 112).

Data Element 112 Sub Element 27 has several bytes within it designated for a plurality of data types. Fields designated for installment payment data include: total number of installments (2-byte field); current installment number (2-byte field); total installment amount (12-byte field in cardholder billing currency); and current installment amount (12-byte field in cardholder billing currency). These fields, when they are populated, may be utilized to determine the total value of an item/authorization.

Accordingly, one or more value(s) located or identified by the RFM processor 418 in records associated with the financial transaction may populate one or more of these standardized fields associated with installment payment plans, and may comprise or be used to derive the recurring transaction indicator(s).

However, merchants often fail to properly populate these fields and/or such fields may be unavailable to the RFM processor 418. Therefore, the RFM processor 418 may also or alternatively be configured to analyze recency, frequency, and/or monetary value attributes or characteristics of the financial transaction and/or of previous financial transactions to generate the recurring transaction indicator(s). In one or more embodiments, the RFM processor 418 may comprise a deep learning model that factors in the fit of non-string data to the entity (ies) identified in feed-forward data. More particularly, the RFM processor 418 may analyze whether timing, recurrence, and/or value amount of the transaction for each entity resolved from the feed-forward data fit, within statistical significance, to previous transactional data associated with same.

Where, for example, the recurring transaction indicator is a score forced to a scale—e.g., with a higher number such as 1 being associated with certainty that the payment is under an installment plan and a lower number such as 0 being associated with no evidence of association with an installment plan—recent payments fitting an installment plan profile or pattern, frequent payments fitting an installment plan profile, and/or close or matching monetary value(s) across such payment(s) may all push the recurring transaction indicator higher wherever the present financial transaction matches such attribute(s) and/or pattern(s). One of ordinary skill will appreciate, however, that other scales, other contributing factors or attributes, and other means of calculation and/or algorithm(s) may be used to extract, derive, and/or generate the recurring transaction indicator(s) within the scope of the present invention.

In each case, the recurring transaction indicator(s) may be inputted to the entity service 406 to support probabilistic operations of the entity service 406 for standardized entity identification.

The customer edit or input module 420 may interface with and/or otherwise receive input from customer(s) relevant to creating and/or revising token mappings for standardized entity identification. More particularly, the customer(s) may review actual or attempted mapping(s) of string(s) and/or entity (ies) to a standardized entity represented in the entity ID database, and may react by providing input consumed by the entity service 406. The customer may, in one or more embodiments, be an open banking account holder or customer of a financial service provider providing an open banking platform or the like to account holders or consumers and implementing the entity service 406 for standardized entity identification.

For example, one or more string(s) and tentatively associated entity (ies)—for example, merchant(s)—and/or the memo field itself corresponding to the financial transaction or one or more previous financial transaction(s) may be displayed to the account holder associated with such transaction(s). The display (e.g., display 50) may be in connection with a user interface populated at least in part by the server(s) 14 of the open banking platform, and/or may be performed by a web browser. The web browser may report back, and/or may execute an add-on, cookie, extension, or the like for reporting back, the consumer input(s). Also or alternatively, a third party application (e.g., social media network or the like) may be configured to report the consumer input(s) relating to the transaction(s). In one or more embodiments, the consumer input or feedback is provided via an API 16, directly to the server(s) 14, and/or otherwise within the scope of the present invention.

In one or more embodiments, the consumer input or feedback comprises an edit to the text or other symbols displayed to the consumer. For example, the consumer may edit an incomplete or ambiguous business entity name, with the edits comprising the input provided by the customer edit or input module 420 to the entity service 406. For another example, the consumer may be presented with a listing of possible entities (e.g., merchants) who may be associated with a financial transaction, and the consumer may select one or more of those entities as being more or most likely to be the correct entity participating in the financial transaction. For yet another example, consumer input may comprise entry of an emoticon or other symbol, and/or corresponding text, which might be analyzed by the customer input module 420 and/or NLP 410 and identified as confirmatory or not confirmatory with respect to such displayed information. In one or more embodiments, the consumer may provide other aliases, truncated versions of such name(s), or other information (whether uniquely identifying or not) that may be used to generate token mappings or otherwise link string(s) to entity (ies) in the entity service 406.

One of ordinary skill will appreciate that other forms of input/output, and not just display and interaction via a user interface, for obtaining customer feedback and input are within the scope of the present invention.

Further, completed standardized entity identification leads to output of the identified entity in connection with the financial transaction from output module 422. More particularly, in the illustrated embodiment, output module 422 generates output 424 including a standardized name for the identified standardized entity as well as any partner-required fields. Accordingly, the exemplary system includes a partner requirements module 426. The partner requirements module 426 stores and provides datapoints, formats, and similar requirements for shaping output 424 from the output module 422. The partner requirements module 426 may take input from partners—such as, e.g., third party businesses, financial service provider(s), and/or financial institution(s)—having an interest in the contents of the output 424 to enable provision of related services, billing arrangements or the like. The output module 422 may access the data required to fulfill any such partner requirements from other components of the system, such as the entity ID database 414, the entity service 406 and/or third party APIs 16.

In one or more embodiments, the FIDI 412, merchant database 416, customer edit module 420, and/or partner requirements module 426 will be provided via respective ones of the APIs 16, though it is foreseen that two (2) or more of these functions or modules may be provided by a single API 16 and/or may be internal (e.g., implemented by one or more server(s) 14) within the scope of the present invention. Moreover, in one or more embodiments, the lookup table 408, NLP 410, entity service 406, RFM processor 418, entity ID database, and output module 422 are internal (e.g., implemented by one or more server(s) 14), though it is foreseen that one or more of these functions or modules may instead be external and/or implemented by or executed on one or more computers 12 and/or via one or more APIs 16 within the scope of the present invention.

It should be appreciated that the components illustrated in FIG. 4 may be embodied within, executed by, and/or distributed across the exemplary devices discussed above, or according to a different physical and/or logical layout, within the scope of the present invention. Moreover, the logical components illustrated in FIG. 4 and discussed above are not to be interpreted as having strict physical and/or functional boundaries, with the illustration serving merely as an example to clarify discussion. Further, as noted in the discussion that follows, one or more of the components and/or device illustrated in FIGS. 1-4 may be omitted or configured differently within the scope of the present invention. For example, the FIDIs 412 may be omitted and/or the data provided thereby may instead be provided through other than direct integrations within the scope of the present invention. For another example, aspects and/or data/algorithms attributed separately to the lookup table 408, entity service 406, and/or entity ID database 414 may be combined and/or otherwise distributed logically and/or physically within the scope of the present invention.

Through hardware, software, firmware, or various combinations thereof, the processing elements 32, 52 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled.

### Exemplary Computer-Implemented Method for Feed-Forward, Feed-Backward Entity Standardization

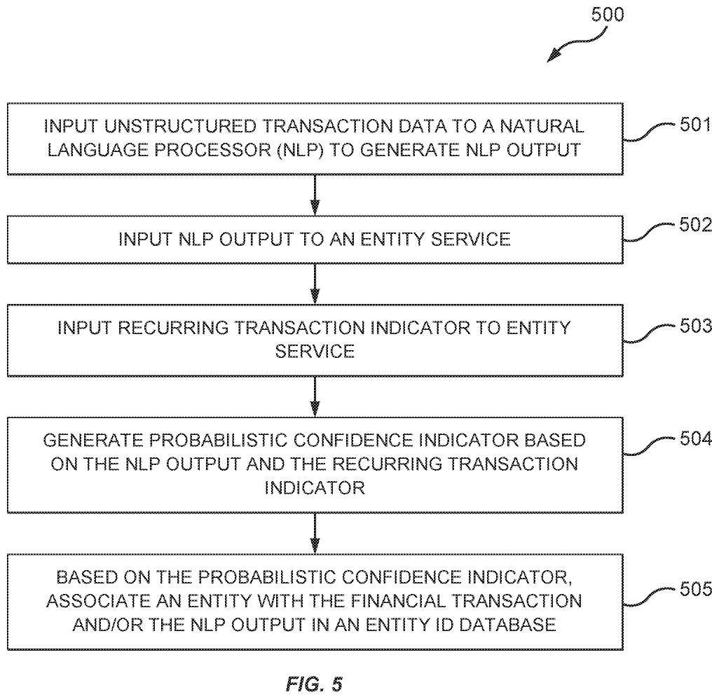

FIG. 5 depicts a flowchart including a listing of steps of an exemplary computer-implemented method 500 for feed-forward, feed-backward entity standardization. The steps may be performed in the order shown in FIG. 5, or they may be performed in a different order. Furthermore, some steps may be performed concurrently as opposed to sequentially. In addition, some steps may be optional.

The computer-implemented method 500 is described below, for ease of reference, as being executed by exemplary devices and components introduced with the embodiments illustrated in FIGS. 1-4. For example, the steps of the computer-implemented method 500 may be performed by the computer(s) 12, the server(s) 14, the APIs 16, and the network(s) 18, 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention and, in many embodiments, will be performed by a single computing device or server. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 501, unstructured transaction data corresponding to a financial transaction may be input to a natural language processor (NLP) to generate NLP output comprising a portion of the unstructured transaction data. Step 501 may be executed by one or both of a computing device and a server. In one or more embodiments, step 501 is executed by a server operated by a financial service provider providing an open banking platform including an entity service for probabilistic standardized entity identification.

The unstructured transaction data may be obtained, and the inputting step may be performed, periodically, continuously, and/or upon request from a variety of sources. For example, unstructured transaction data may be obtained from an API periodically and/or in batches, in real-time during processing of the financial transaction, or otherwise without departing from the spirit of the present invention. In one or more embodiments, an automated data acquisition process may cause intermittent batch downloads of unstructured transaction data from APIs associated with financial institutions, financial service providers, and/or third-party databases storing such data.

In addition, the NLP may take as input output(s) from an upstream lookup table, as discussed in more detail above. For example, the output(s) from the upstream lookup table may comprise the results of distance metric and other analyses performed by the lookup table in an attempt to provide deterministic standardized entity identification, and together with those portion(s) of the unstructured transaction data on which such analyses are based, may be taken as input to the NLP.

As discussed in more detail above, the NLP output may comprise portion(s) of the unstructured transaction data and/or lookup table output identified by the NLP as having potential entity-identification meaning for downstream probabilistic analyses of an entity (discussed in more detail below). The NLP may comprise deep learning model(s), such as a named entity recognition (NER) model and/or a masked language model (MLM). Despite the low or non-existent syntax in the unstructured transaction data, unstructured nature of the transaction data and output from the lookup table, the NLP detects sentence and/or fragment boundaries, character usage, punctuation, and/or nonce characters, identifies word usage, choices and relative position patterns, and otherwise maps the unstructured transaction data and/or output from the lookup table according to pre-established conventions to extract strings and combinations of strings which may be used to identify one or more entities involved in the financial transaction. It should also be noted that the data and information extracted from the unstructured transaction data and/or lookup table by the NLP may undergo additional processing—e.g., for normalization, correcting for missing letters and/or misspellings, or the like—within the scope of the present invention and prior to input into the entity service.

Referring to step 502, the NLP output may be input to the entity service. As discussed above, the NLP output may comprise strings and combinations of strings, extracted from the unstructured transaction data and/or output from the lookup table, which may be used to identify one or more entities involved in the financial transaction.

Step 502 may be executed by one or both of a computing device and a server. In one or more embodiments, step 502 is executed by a server operated by a financial service provider providing an open banking platform including an entity service for probabilistic standardized entity identification.

Referring to step 503, a recurring transaction indicator may also be input to the entity service. Step 503 may be executed by one or both of a computing device and a server. In one or more embodiments, step 503 is executed by a server operated by a financial service provider providing an open banking platform including an entity service for probabilistic standardized entity identification. Also or alternatively, the recurring transaction indicator may be generated by the server operated by the financial service provider providing the open banking platform including the entity service.

As discussed above, in one or more embodiments, a record associated with the financial transaction will be parsed or reviewed by an RFM processor to locate a value populating a data field assigned for use with transactions under installment payment plans by a standardized financial transaction format. One or more value(s) located or identified by the RFM processor in records associated with the financial transaction may populate one or more of these standardized fields associated with installment payment plans, and may comprise or be used to derive the recurring transaction indicator(s).

However, merchants often fail to properly populate these fields. Therefore, the RFM processor may also or alternatively be configured to analyze recency, frequency, and/or monetary value attributes or characteristics of the financial transaction and/or of previous financial transactions to generate the recurring transaction indicator(s). For example, where the recurring transaction indicator is a forced scale score, recent payments fitting an installment plan profile or pattern, frequent payments fitting an installment plan profile, and/or close or matching monetary value(s) across such payment(s) may all push the recurring transaction indicator higher on the exemplary scale wherever mirroring the present financial transaction. One of ordinary skill will appreciate, however, that other scales, other contributing factors or attributes, and other means of calculation and/or algorithm(s) may be used to extract, derive, and/or generate the recurring transaction indicator(s) within the scope of the present invention.

Each transaction record analyzed by the RFM processor may be a transaction request message, a transaction approval message, a ledger and/or other record of past or present transactions, or a portion thereof. The transaction records may be recorded and stored in any of numerous ways. For example, a credit and/or payment processing network may keep a record of all transactions requested and approved. The record(s) may be provided via API and/or stored by a computing device controlled by, accessible to and/or also executing an entity service in accordance with embodiments of the present invention. These records may be organized chronologically, by amount, by type, by the consumer, by merchant, by merchant type, by acquirer, by issuer, or in some other manner. Thus, the RFM processor may compare numerous transaction records based upon any of numerous criteria. The RFM processor may analyze transaction records for patterns to identify installment payments.

For example, first and second transaction records associated with an identified consumer or account holder may include one or both of amount identifier and date identifier data fields and corresponding elements or values. The amount identifier may include a dollar amount, an interest amount, a value amount, or other monetary amount indication associated with the transaction. The date/time identifier may include date information, time information for the request, time information for approval, and/or time information for the completion. The transaction record(s) may also include a merchant type identifier. The merchant type identifier is indicative of the type of merchant involved in the transaction. It should be appreciated that installment payments will be most common with certain types of merchants, such as the smartphone retailers. For certain types of merchants, such as those that sell a wide variety of goods, these installment payments may also be more common because it is not a normal transaction for the merchant. The transaction records may also include other information that may be relevant to the analysis, such as a description of the goods and services involved.

Such transaction records may be analyzed to isolate repeat transactions on the same (or similar) account, regardless of whether they are designated in a standardized manner as recurring or installment plan-related (as discussed above). For example, if the first transaction record is a $20 authorization request transmitted by a communication technology provider within an ecommerce payment channel, the RFM processor may isolate transactions represented in the historical database that involve respective ones of historical transaction records for elements that suggest the presence of an underlying installment payment plan corresponding to the authorization request. As noted elsewhere herein, such elements may evidence repeat payments for the exact same amount, made on the same day of month, made using the same account number, made recently, and/or that otherwise fit the profile of a typical installment plan payment. In a preferred embodiment, transaction records already marked as associated with an installment plan may not be analyzed to determine such association. However, in an embodiment, such already-marked transaction records may be used to confirm the association of other corresponding payments with such an installment plan even where the other corresponding payments are initially unmarked.

The RFM processor may perform a historical analysis for one or more of the consumers or account holders identified in the transaction records. This historical analysis may identify trends in the purchasing of the individual consumer or account holder, with or without consideration of particular merchant(s). If the account holder has a pattern of purchases indicative of fraudulent installment payment behavior, it may enhance confidence in assessment(s) regarding non-reported installment plan(s), lead to one or more flag(s) for further analysis, or otherwise inform implementation of the services outlined herein. The historical analysis may also analyze other charges of the consumer to explain the transaction record(s). For example, in some instances, the account holder may make payments for a monthly service plan to a local smartphone retailer, instead of directly to the service plan provider. Based on this determination, the RFM processor may scrutinize other historical transaction records to determine whether there are other charges related to cell phones transacted by the account holder. For instance, if the account holder has a monthly charge from a service plan provider and a new potentially recurring charge from a local smartphone retailer, it is more likely that the new potentially recurring charge is an installment plan.

As noted above, the analyses of the RFM processor may produce one or more recurring transaction indicator(s)—e.g., scaled scores proportionate to a level of confidence that the financial transaction is part of an installment plan (such as by exhibiting a corresponding pattern in the historical transaction data)—which may be inputted to the entity service to support probabilistic operations of the entity service for standardized entity identification.

Referring to step 504, the entity service may generate a probabilistic confidence indicator based on the NLP output and the recurring transaction indicator. The probabilistic confidence indicator may meet or exceed a threshold for standardized matching of an entity to the financial transaction.

Step 504 may be executed by one or both of a computing device and a server. In one or more embodiments, step 504 is executed by the server operated by the financial service provider providing the open banking platform including the entity service.

In one or more embodiments, the entity service implements a probabilistic classification and matching algorithm, which may comprise an artificial intelligence classifier coupled to a fuzzy searching algorithm. For example, the fuzzy searching algorithm may analyze the strings and substrings provided by the NLP output and/or the recurring transaction indicator(s) (and, optionally, output from the lookup table(s)) to locate items that resemble known identity matching data stored by and/or accessible to the entity service. For example, the entity service may store and/or access known entities and associated metadata about each such entity.

The entities, as noted above, may include merchants, payment processors, payrolls services, and/or other financial service providers and/or financial institutions. The metadata stored for each such known entity may include proper names, corporate names, geographic descriptors, size data, aliases, merchant categories, product categories, installment plan characteristics based on such categories and/or historical transaction records, firmographic data, historical transaction records and/or transaction patterns derived therefrom, and other potentially distinctive entity data for uniquely identifying the entities.

The probabilistic classification and matching algorithm may utilize distance metrics to analyze the strings and substrings provided by the NLP output and/or the recurring transaction indicator(s) (and, optionally, output from the lookup table(s)) against the entity data and metadata stored by and/or accessible to the entity service. Matches or approximate matches and/or the lack thereof may be recorded, along with an indicator (e.g., a scalar indicator) of how closely each match was made. The output of the fuzzy searching algorithm may be fed to the probabilistic feature(s) of the classification and matching algorithm. For example, an artificial intelligence classifier may embody one or more of the following for Bayesian classification of one or more entities based on the input to the entity service: a neural network, case based reasoning, a decision tree, a genetic algorithm, fuzzy logic, and/or rules and constraints.

In each case, the artificial intelligence classifier or analogous feature(s) of the classification and matching algorithm generates a list of one or more entities (e.g., merchants) and attaches a matching likelihood or probabilistic confidence indicator to each of the entities based on, for example, the number of matches found, the types of matches found, and how closely each match was made. It should also be appreciated that the lack of a match, particularly where one would be expected, may also be considered by the artificial intelligence classifier in developing the list and corresponding probabilistic confidence indicators.

For example, the entity data and metadata stored and/or accessed by the entity service and mapped to standardized entities may be labeled according to data type—for example, zip code, alias, corporate name, distinguishable historical transaction pattern, etc.—and each matched data type may carry a more or less significant distinctiveness weighting within the classifier depending on how likely such a match is to uniquely identify an entity. Moreover, the weighting and/or additional weighting(s) may vary based on other factors, such as the number of data types matched, the specified combinations of matched data types (e.g., matches across two (2) particular data types may carry a high significance weighting, whereas a match across three (3) other particular data types may carry less significance weighting), and/or how closely the matches were made (e.g., an exact match may be quite significantly weighted but such weighting may drop precipitously and/or exponentially for less close matches for one data type, whereas weighting for another data type may vary proportionately with the number characters matched).

As noted above, an artificial intelligence classifier may capture and emulate the complex relationships between data types, string matching, distance metrics, and the like described herein. Moreover, such artificial intelligence classifiers may be automatically retrained—in addition to, for example, the NLP—based on failure or achievement of standardized entity identification and/or feed-backward input to the entity service, as described in more detail below. However, a weighted summation or similar computation may also or alternatively cooperate with a fuzzy searching or other search algorithm to form the classification and matching algorithm in one or more embodiments.

It should also be noted that “weighting” described herein may be replaced and/or supplemented by other mathematical features configured to emphasize or de-emphasize the presence or absence of string(s) and combinations of different types of strings in multifactorial analysis by the classification and matching algorithm within the scope of the present invention.

In one or more embodiments, feed-backward input from the RFM processor comprising recurring transaction indicator(s) are analyzed by the entity service to generate the list of entity (ies) and corresponding probabilistic indicator(s). For example, analysis by the entity service of feed-forward strings from the NLP and/or lookup table(s) (and, optionally, of a FIDI feed) may result in a probabilistic confidence indicator below a threshold required for standardized entity identification uniquely identifying an entity at a required level of resolution. The threshold may be a pre-determined distance threshold of the distance metric(s) implemented by the entity service. However, the feed-backward input from the RFM processor—which, again, may include a recurring transaction indicator comprising a scaled score or value accompanied by a scalar or the like that is reflective of a level of confidence that the financial transaction is part of an installment payment plan—may move the probabilistic confidence indicator over the threshold and permit standardized entity identification.

For example, where recency, frequency, and monetary value of one or more prior historical transactions and/or merchant entity behavior suggest a high level of confidence that the present financial transaction is part of an installment plan for one of the merchant entities on the list generated by the entity service, the corresponding recurring transaction indicator may be sufficient to push the probabilistic confidence indicator over the threshold for standardized entity identification.

In one or more embodiments, the threshold for standardized entity identification may not be met. For example, a recurring transaction indicator correlating to a low score from the RFM processor—indicating that the financial transaction is unlikely to be part of an installment payment plan—may reduce the probabilistic confidence indicator for entity (ies) on the list that exclusively or primarily bill under such installment payment plans. Accordingly, the entity service may—rather than concluding with a standardized entity identification—instead merely identify a suggested or most likely entity from among the list of entities (or a new entity identification may be generated, for example if none of the listed entities match sufficiently to reach a likely or suggested status).

Wherever a new entity identification is generated, one or more strings analyzed by the entity service according to the description above may be automatically added to the data and metadata stored regarding the new entity in the entity service and/or entity ID database. Whether a particular analyzed string is added to the entry associated with the new entity may depend, for example, on a template for new entity creation, which treats certain data and strings analyzed by the entity service from the feed-forward input and certain of the feed-backward input as being inherently distinctive and/or distinguishing in the first instance. However, such template(s) and/or corresponding new entity data and/or metadata may be revised based on learning within the system, described in more detail elsewhere herein.

It should also be noted that the classification and matching algorithm of the entity service may utilize the recurring transaction indicator in other ways to distinguish between listed potential entity matches via the probabilistic confidence indicators. For example, a recurring transaction indicator reflecting a high likelihood of classification under an installment plan may lead to a lower probabilistic confidence indicator for one or more entities on the list which otherwise match feed-forward data and string(s) and also participate in installment plan payments, but which are rarely or never associated with installment plan payments of the type or magnitude represented by the instant financial transaction (even where such entity (ies) might may have historically charged such payments outside of installment plans). One of ordinary skill will appreciate that a variety of datapoint(s) may be related, e.g., by an artificial intelligence classifier, to the recurring transaction indicator and/or classes distinguished thereby within the scope of the present invention.

Referring now to step 505, based on the probabilistic confidence indicator, an entity may be associated with the financial transaction and/or the NLP output in the entity identification database. More particularly, in one or more embodiments, the entity service may generate a probabilistic confidence indicator for one of the entities on the list of entities which exceeds the pre-determined threshold for standardized entity identification and, accordingly, will associate the transaction and/or the feed-forward string(s) and/or data (e.g., output from the NLP, lookup table(s), and/or FIDI feed) with the entity in the entity ID database.

Step 505 may be executed by one or both of a computing device and a server. In one or more embodiments, step 505 is executed by the server operated by the financial service provider providing the open banking platform including the entity service.

The updated data and string(s) for the entity in the entity ID database may automatically be incorporated into the upstream lookup table and/or used to retrain the NLP for use in connection with identifying entities in future financial transactions. For example, a string having a given data type which is heavily weighted for distinguishability between entities relative to other possible string(s) and/or string type(s), and that is associated with the entity according to the standardized entity identification described above, may be mapped as a new token mapping to the identified entity and/or its unique identifier(s) in the lookup table. Future analyses by the lookup table on future transactions may search for exact or approximate matches to such string(s) and affirmatively identify the entity based thereon, e.g., without the need for repeated probabilistic analyses within the entity service.

Accordingly, probabilistic analyses by the entity service help evolve the deterministic capabilities of upstream lookup table and other components, progressively and automatically increasing the efficiency and operation of the entity identification system.

In another example, the lookup table may be reconfigured or retrained based on the failure of certain string(s) to lead to a standardized entity identification. More particularly, where a string is found and identified but is ultimately insufficient to push the probabilistic confidence indicator high enough to match the threshold for standardized matching, the string and/or its corresponding type may be deemphasized and/or the manner by which it is captured and/or analyzed may be reconfigured in future implementations of the lookup table.

For another example, the NLP may be reconfigured based on the matching and/or identifying string(s) (e.g., the NLP output) which contribute to the standardized entity identification. The reconfigured NLP may more adeptly look for and produce output focused on such string(s) in connection with future transactions. Also or alternatively, such a reconfigured NLP may prioritize the same or similar string type(s) in producing output for the entity service in connection with future transactions, for example where those string types were observed as having favorable characteristics with respect to distinguishing entities from one another. In another example, the NLP may be reconfigured or retrained based on the failure of certain string(s) to lead to a standardized entity identification. More particularly, where a string is found and identified but is insufficient to push the probabilistic confidence indicator high enough to match the threshold for standardized matching, the string and/or its corresponding type may be deemphasized and/or its weighting may be reduced by reconfiguration and/or retraining of the NLP.

The method may include additional, less, or alternate steps and/or device(s), including those discussed elsewhere herein. For example, in one or more embodiments, the entity service will generate the list of one or more entity (ies) and/or the corresponding probabilistic confidence indicator(s) based on additional feed-backward data. In one or more embodiments, feed-backward input from a merchant database and/or a customer edit or input module may additionally be incorporated into the analysis (e.g., distance metric(s)) implemented by the entity service for generation of the list of one or more entity (ies) and/or the corresponding probabilistic confidence indicator(s), in each case as discussed in more detail below.

In addition, it should be noted that classification and identification processes for a single financial transaction performed by embodiments of the present system may be repeated or otherwise performed in parallel several times, respectively in connection with identifying entities performing different roles and/or serving in different capacities in the transaction. For example, one set of entity service operational parameters, rules, and/or the like may be applicable to standardized identification of an entity filling one role in connection with a transaction (e.g., acquirer), whereas a different set of entity service operational parameters, rules, and/or the like may be applicable to standardized identification of the same or another entity filling a different role in connection with a transaction (e.g., a payment processing network). Accordingly, a separate analysis may be performed for each role in question without departing from the spirit of the present invention.

Moreover, one or more output(s) may be generated based on the standardized entity identification for the present financial transaction. For example, in one or more embodiments, a partner requirements database may be accessed, defining the preferred and/or required elements of any output of the standardized entity identification system and/or methods. An output module may access the requirements database, access one or more additional data sources (e.g., the merchant database and/or entity ID database) to acquire the required and/or preferred data defined in the requirements database, and configure one or more output(s) (e.g., report(s) and/or new database entries) to include the required and/or preferred data.

### Exemplary Computer-Implemented Method for Feed-Forward, Feed-Backward Entity Standardization

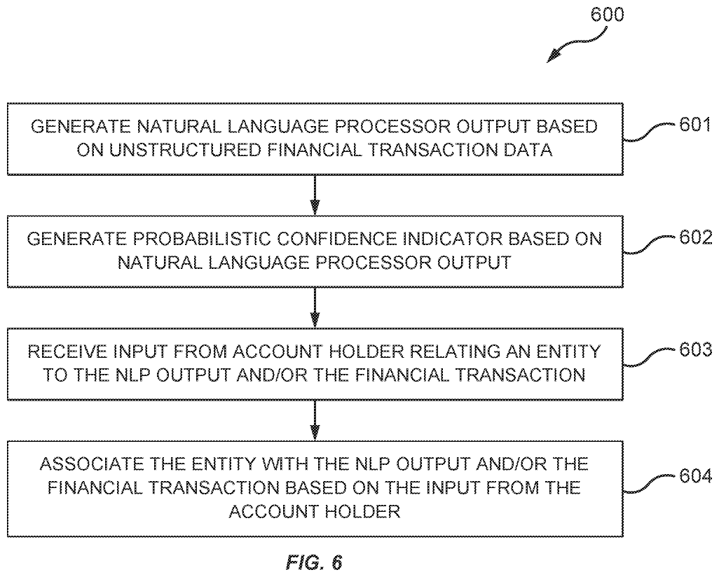

FIG. 6 depicts a flowchart including a listing of steps of an exemplary computer-implemented method 600 for feed-forward, feed-backward entity standardization. The steps may be performed in the order shown in FIG. 6, or they may be performed in a different order. Furthermore, some steps may be performed concurrently as opposed to sequentially. In addition, some steps may be optional.

The computer-implemented method 600 is described below, for ease of reference, as being executed by exemplary devices and components introduced with the embodiments illustrated in FIGS. 1-4. For example, the steps of the computer-implemented method 600 may be performed by the computer(s) 12, the server(s) 14, the APIs 16, and the network(s) 18, 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention and, in many embodiments, will be performed by a single computing device or server. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 601, unstructured transaction data corresponding to a financial transaction may be input to a natural language processor (NLP) to generate NLP output comprising a portion of the unstructured transaction data. Step 601 may be executed by one or both of a computing device and a server. In one or more embodiments, step 601 is executed by a server operated by a financial service provider providing an open banking platform including an entity service for probabilistic standardized entity identification.

The unstructured transaction data may be obtained, and the inputting step may be performed, periodically, continuously, and/or upon request from a variety of sources. For example, unstructured transaction data may be obtained from an API periodically and/or in batches, in real-time during processing of the financial transaction, or otherwise without departing from the spirit of the present invention. In one or more embodiments, an automated data acquisition process may cause intermittent batch downloads of unstructured transaction data from APIs associated with financial institutions, financial service providers, and/or third-party databases storing such data.

In addition, the NLP may take as input output(s) from an upstream lookup table, as discussed in more detail above. For example, the output(s) from the upstream lookup table may comprise the results of distance metric and other analyses performed by the lookup table in an attempt to provide deterministic standardized entity identification, and together with those portion(s) of the unstructured transaction data on which such analyses are based, may be taken as input to the NLP.

As discussed in more detail above, the NLP output may comprise portion(s) of the unstructured transaction data and/or lookup table output identified by the NLP as having potential entity-identification meaning for downstream probabilistic analyses of an entity. The NLP may comprise deep learning model(s), such as a named entity recognition (NER) model and/or a masked language model (MLM). The NLP may be constituted and may operate substantially in the manner described in connection with the exemplary system and method 500 above, except wherever described otherwise and/or supplemented in connection with method 600.

Referring to step 602, the entity service may generate a probabilistic confidence indicator based on the NLP output. The entity service may be constituted and may operate substantially in the manner described in connection with any of the exemplary system and method 500 above, and/or 700, 800 below, except wherever described otherwise and/or supplemented in connection with method 600.

More particularly, the entity service's probabilistic computations and generation of corresponding confidence indicators for one or more candidate entity (ies) may, in addition to the NLP output, also take into account one or more of the following within the scope of the present invention: output from the upstream lookup table(s); FIDI feed data; RFM processor feed-backward data; merchant database feed-backward data and/or metadata; and/or account holder input comprising feed-backward data relating the financial transaction to one or both of the NLP output and an entity (as discussed in more detail below).

Step 602 may be executed by one or both of a computing device and a server. In one or more embodiments, step 602 is executed by the server operated by the financial service provider providing the open banking platform including the entity service.

In one or more embodiments, the probabilistic confidence indicator may meet or exceed a threshold for standardized matching of an entity to the financial transaction. For example, an account holder associated with the financial transaction may provide feed-backward input on the unstructured transaction data corresponding to the financial transaction (i.e., the data that is input to the NLP and/or portions thereof, such as portions extracted by the NLP), as described in more detail below. Such feed-backward input from the account holder may be included in the entity service's probabilistic computations and generation of the corresponding probabilistic confidence indicators. The resulting probabilistic confidence indicator for an entity may meet or exceed a threshold for standardized matching of the entity to the financial transaction.

However, analysis by the entity service of feed-forward strings from the NLP and/or lookup table(s) (and, optionally, of a FIDI feed), and/or of feed-backward strings from the RFM processor and/or merchant database, may result initially in probabilistic confidence indicator(s) below the threshold required for standardized entity identification uniquely identifying an entity at a required level of resolution. Feed-backward input from the account holder, discussed in more detail below, may move such a probabilistic confidence indicator over the threshold permitting standardized entity identification.

Referring to step 603, input may be received from the account holder relating the entity to one or both of the NLP output and the financial transaction. In one or more embodiments, step 603 is executed by the server operated by the financial service provider providing the open banking platform including the entity service. Also or alternatively, the message(s) or alternatively-formatted output seeking account holder input may be generated by the server operated by the financial service provider providing the open banking platform including the entity service.

Turning now to types of and mechanisms for account holder feed-backward input, it is again noted that the account holder may be presented with a representation of the financial transaction comprising one or more of the following: a description of the financial transaction, which may be partly or entirely structured and/or unstructured (i.e., including data from the memo field); one or more portion(s) of the NLP output (e.g., comprising one or more extracted string(s) and/or combinations thereof); one or more portion(s) of the output from the upstream lookup table(s); and/or an initial identification of one or more entities by the entity service (i.e., one or more entities having the highest-matching probabilistic confidence indicator(s) from an initial computation by the entity service, particularly where such indicator(s) do not reach the threshold for standardized entity identification).

The representation of the financial transaction may be transmitted to an account holder computing device (e.g., mobile device, desktop, or the like) by the financial service provider providing the open banking platform including the entity service, by a financial institution and/or payment processing network facilitating the financial transaction, and/or by another entity. The representation may be in the form of a summary of the financial transaction, of the memo field itself, of a questionnaire offering multiple entities for the account holder to select among for association with the financial transaction, of a request to confirm an initially-identified potential entity, and/or may be in another form within the scope of the present invention. The representation may be displayed or otherwise output to the account holder at the account holder computing device to prompt entry of the input from the account holder.

The account holder feed-backward input may comprise one or more of: an edit to one or more aspect(s) or portion(s) of the representation of the financial transaction (e.g., an inline clarification or revision impacting a string classified as potentially representing the entity to be resolved); a response selecting one of the entities listed in a questionnaire comprising the representation; an emoticon or emoji (e.g., with an emoticon or emoji interpreted as likely to be positive or confirmatory being ostensible confirmation, within a degree of confidence, of an entity included in the representation); and/or other alphanumeric symbols and/or emojis/emoticons input by the account holder.

In one or more embodiments, the entity service stores a key mapping actions and input types, and the input itself, of the account holder to a pre-determined meaning (i.e., technical impact on computations of the entity service) and certainty score. For example, where the action is an inline edit of a string categorized as likely being a name for a putative entity involved in the transaction, and the edited/added string(s) match or nearly match known portion(s) of an entity name (e.g., “inc.” or “LLC” or a portion of a stored entity name in the entity identification database), the key stored by the entity service may rate a high certainty score that the resulting edited string may be relied on as representative of the identity of the closest-matching entity stored in the database. Under such circumstances, the mapping key may weight more heavily such input, at least in part because an inline edit is likely the result of high engagement and substantive review on the part of the account holder.

On the other hand, a more ambiguous action of the account holder—such as, for example, a “like” reaction or a smile emoji—may moderately increase a probabilistic confidence indicator for an entity initially included in the representation of the transaction based on an initial probabilistic confidence indicator which did not meet the threshold for standardized entity identification. Under such circumstances, the mapping key may weight less heavily such input, at least in part because an emoji may be applied with less effort by the account holder and/or without significant attention being paid to the contents of the representation. In this manner, the entity service may take account in computations of both the type of action or input provided by the account holder, and of the content of the input itself.

In one or more embodiments, the account holder input is received and incorporated into an initial probabilistic confidence indicator computation of the entity service. Also or alternatively, the account holder input is incorporated into one or more later iterations on the computation of probabilistic confidence indicators. For example, and as discussed above, the input may be sought and obtained without first identifying a potential entity via the probabilistic computations of the entity service, and/or the input may be sought after an initial computation of a probabilistic confidence indicator for the entity has been done, but where the resulting indicator is below the threshold for standardized entity identification. In either case, the entity service may generate the probabilistic confidence indicator based on the account holder input and/or may otherwise rely on the account holder input to confirm or reject identification of the potential entity in connection with the financial transaction.

Referring to step 604, based on the input from the account holder, the entity may be associated with one or both of the financial transaction and the NLP output in the entity identification database. In one or more embodiments, step 604 is executed by the server operated by the financial service provider providing the open banking platform including the entity service.

Returning to the examples discussed in more detail above, the input from the account holder may expressly or implicitly confirm an initial identification of an entity by the entity service, particularly where the initial identification corresponds to a probabilistic confidence indicator below the threshold for standardized entity identification. Also or alternatively, the input from the account holder may be incorporated as an input by the entity service for generation of a probabilistic confidence indicator that meets or exceeds the threshold for standardized entity identification. In either case, the input from the account holder may cause the server and/or entity service to associate the entity with one or both of the financial transaction and the corresponding NLP output in the entity identification database.

In one or more embodiments, the threshold for standardized entity identification may not be met, even considering the account holder input. Accordingly, the entity service may—rather than concluding with a standardized entity identification for an existing entity—instead generate a new entity identification. Wherever a new entity identification is generated, one or more strings analyzed by the entity service according to the description above may be automatically added to the data and metadata stored regarding the new entity in the entity service and/or entity ID database. Whether a particular analyzed string is added to the entry associated with the new entity may depend, for example, on a template for new entity creation, which treats certain data and strings analyzed by the entity service from the feed-forward input and certain of the feed-backward input as being inherently distinctive and/or distinguishing in the first instance. However, such template(s) and/or corresponding new entity data and/or metadata may be revised based on learning within the system, described in more detail elsewhere herein.

Moreover, and again as discussed in more detail in connection with the method 500 above, in one or more embodiments the entity is associated with the transaction and/or the feed-forward string(s) and/or data (e.g., output from the NLP, lookup table(s), and/or FIDI feed) with the entity in the entity ID database.

The updated data and string(s) for the entity in the entity ID database may automatically be incorporated into the upstream lookup table and/or used to retrain the NLP for use in connection with identifying entities in future financial transactions. Such retraining and/or updating may occur substantially in accordance with the description provided in connection with the exemplary system and any of methods 500 above, and/or 700, 800 below, except wherever described otherwise and/or supplemented in connection with method 600.

The method may include additional, less, or alternate steps and/or device(s), including those discussed elsewhere herein. For example, in one or more embodiments, the entity service will generate the list of one or more entity (ies) and/or the corresponding probabilistic confidence indicator(s) based on additional feed-backward data. In one or more embodiments, feed-backward input from a merchant database and/or RFM processor may additionally be incorporated into the analysis (e.g., distance metric(s)) implemented by the entity service for generation of the list of one or more entity (ies) and/or the corresponding probabilistic confidence indicator(s), in each case as discussed in more detail elsewhere herein.

In addition, it should be noted that classification and identification processes for a single financial transaction performed by embodiments of the present system may be repeated or otherwise performed in parallel several times, respectively in connection with identifying entities performing different roles and/or serving in different capacities in the transaction. For example, one set of entity service operational parameters, rules, and/or the like may be applicable to standardized identification of an entity filling one role in connection with a transaction (e.g., acquirer), whereas a different set of entity service operational parameters, rules, and/or the like may be applicable to standardized identification of the same or another entity filling a different role in connection with a transaction (e.g., a payment processing network). Accordingly, a separate analysis may be performed for each role in question without departing from the spirit of the present invention.

Moreover, one or more output(s) may be generated based on the standardized entity identification for the present financial transaction. For example, in one or more embodiments, a partner requirements database may be accessed, defining the preferred and/or required elements of any output of the standardized entity identification system and/or methods. An output module may access the requirements database, access one or more additional data sources (e.g., the merchant database and/or entity ID database) to acquire the required and/or preferred data defined in the requirements database, and configure one or more output(s) (e.g., report(s) and/or new database entries) to include the required and/or preferred data.

### Exemplary Computer-Implemented Method for Feed-Forward, Feed-Backward Entity Standardization

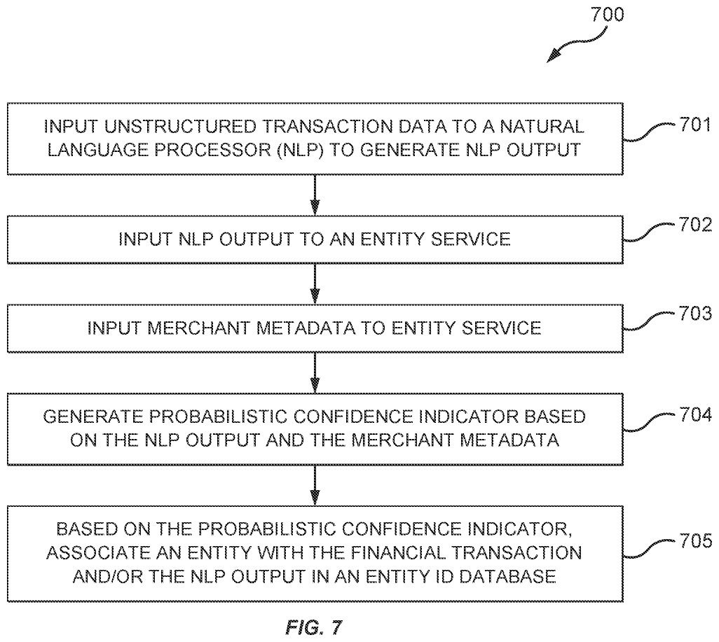

FIG. 7 depicts a flowchart including a listing of steps of an exemplary computer-implemented method 700 for feed-forward, feed-backward entity standardization. The steps may be performed in the order shown in FIG. 7, or they may be performed in a different order. Furthermore, some steps may be performed concurrently as opposed to sequentially. In addition, some steps may be optional.

The computer-implemented method 700 is described below, for ease of reference, as being executed by exemplary devices and components introduced with the embodiments illustrated in FIGS. 1-4. For example, the steps of the computer-implemented method 700 may be performed by the computer(s) 12, the server(s) 14, the APIs 16, and the network(s) 18, 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention and, in many embodiments, will be performed by a single computing device or server. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 701, unstructured transaction data corresponding to a financial transaction may be inputted to a natural language processor (NLP) to generate NLP output comprising a portion of the unstructured transaction data. Step 701 may be executed by one or both of a computing device and a server. In one or more embodiments, step 701 is executed by a server operated by a financial service provider providing an open banking platform including an entity service for probabilistic standardized entity identification.

The unstructured transaction data may be obtained, and the inputting step may be performed, periodically, continuously, and/or upon request from a variety of sources. For example, unstructured transaction data may be obtained from an API periodically and/or in batches, in real-time during processing of the financial transaction, or otherwise without departing from the spirit of the present invention. In one or more embodiments, an automated data acquisition process may cause intermittent batch downloads of unstructured transaction data from APIs associated with financial institutions, financial service providers, and/or third-party databases storing such data.

In addition, the NLP may take as input output(s) from an upstream lookup table, as discussed in more detail above. For example, the output(s) from the upstream lookup table may comprise the results of distance metric and other analyses performed by the lookup table in an attempt to provide deterministic standardized entity identification, and together with those portion(s) of the unstructured transaction data on which such analyses are based, may be taken as input to the NLP.

As discussed in more detail above, the NLP output may comprise portion(s) of the unstructured transaction data and/or lookup table output identified by the NLP as having potential entity-identification meaning for downstream probabilistic analyses of an entity. The NLP may comprise deep learning model(s), such as a named entity recognition (NER) model and/or a masked language model (MLM). The NLP may be constituted and may operate substantially in the manner described in connection with the exemplary system and method 500 above, except wherever described otherwise and/or supplemented in connection with method 700.

Referring to step 702, the NLP output may be input to the entity service. As discussed above, the NLP output may comprise strings and combinations of strings, extracted from the unstructured transaction data and/or output from the lookup table, which may be used to identify one or more entities involved in the financial transaction.

Step 702 may be executed by one or both of a computing device and a server. In one or more embodiments, step 702 is executed by a server operated by a financial service provider providing an open banking platform including an entity service for probabilistic standardized entity identification.

Referring to step 703, merchant metadata for a plurality of merchants may also be input to the entity service. Step 703 may be executed by one or both of a computing device and a server. In one or more embodiments, step 703 is executed by a server operated by the financial service provider providing the open banking platform including an entity service for probabilistic standardized entity identification. Also or alternatively, the merchant metadata may be curated, managed, and/or generated by the server operated by the financial service provider providing the open banking platform including the entity service.

As discussed in more detail above, the merchant metadata may be stored in a merchant database. The merchant database may be an internal or external database managed by a financial institution and/or financial service provider. For example, in one or more embodiments the merchant database is populated, curated, and managed by a payment processing network, gathering, labeling and storing such metadata. More particularly, the database may be populated with historical data collected in connection with payment processing and/or collected from merchants and/or acquirers directly. The data in the merchant database may describe historical transaction trends or behaviors of respective merchants represented and identified therein (e.g., identified according to unique identifiers also used in an entity ID database according to embodiments of the present system). The data in the merchant database may also or alternatively describe attributes of such merchants (e.g., size, merchant category, category codes, firmographic data, and/or the like). As noted here, the merchant database may include historical transaction records and/or include descriptions or metrics relating to historical transaction behaviors of the merchants. Accordingly, embodiments of the present invention may include pre-computed historical transaction records associated with the plurality of merchants represented in the merchant database to derive and store values relating to, summarizing, and/or summing and/or otherwise reflecting such behaviors. In each case, the data of the merchant database (i.e., metadata regarding the merchant(s) represented therein) may be inputted to the entity service to support probabilistic operations of the entity service for standardized entity identification.

Referring to step 704, the entity service may generate a probabilistic confidence indicator based on the NLP output and the merchant metadata. The entity service may be constituted and may operate substantially in the manner described in connection with the exemplary system and any of methods 500, 600 above, and/or 800 below, except wherever described otherwise and/or supplemented in connection with method 700. More particularly, the entity service's probabilistic computations and generation of corresponding confidence indicators for one or more candidate entity (ies) may, in addition to the NLP output and merchant metadata, also take into account one or more of the following within the scope of the present invention: output from the upstream lookup table(s); FIDI feed data; RFM processor feed-backward data; and/or account holder input comprising feed-backward data relating the financial transaction to one or both of the NLP output and an entity (as discussed in more detail above).

Step 704 may be executed by one or both of a computing device and a server. In one or more embodiments, step 704 is executed by the server operated by the financial service provider providing the open banking platform including the entity service.

In one or more embodiments, the probabilistic confidence indicator may meet or exceed a threshold for standardized matching of an entity to the financial transaction. For example, in one or more embodiments, feed-backward input comprising the merchant metadata are analyzed by the entity service to generate the list of entity (ies) and corresponding probabilistic indicator(s). For example, analysis by the entity service of feed-forward strings from the NLP and/or lookup table(s) (and, optionally, of a FIDI feed) may result in a probabilistic confidence indicator below a threshold required for standardized entity identification uniquely identifying an entity at a required level of resolution. The threshold may be a pre-determined distance threshold of the distance metric(s) implemented by the entity service. However, the feed-backward input comprising the merchant metadata may move the probabilistic confidence indicator over the threshold and permit standardized entity identification.

For example, where merchant entity behavior comprising or reflected by the merchant metadata suggest a high level of confidence that the present financial transaction is being transacted with a merchant of substantial size and/or international presence, and only one (1) listed entity matches these criteria, the corresponding merchant metadata may be sufficient to push the probabilistic confidence indicator over the threshold for standardized entity identification.

In one or more embodiments, the threshold for standardized entity identification may not be met. Accordingly, the entity service may—rather than concluding with a standardized entity identification—instead merely identify a suggested or most likely entity from among the list of entities (or a new entity identification may be generated, for example if none of the listed entities match sufficiently to reach a likely or suggested status).

Wherever a new entity identification is generated, one or more strings analyzed by the entity service according to the description above may be automatically added to the data and metadata stored regarding the new entity in the entity service and/or entity ID database. Whether a particular analyzed string is added to the entry associated with the new entity may depend, for example, on a template for new entity creation, which treats certain data and strings analyzed by the entity service from the feed-forward input and certain of the feed-backward input as being inherently distinctive and/or distinguishing in the first instance. However, such template(s) and/or corresponding new entity data and/or metadata may be revised based on learning within the system, described in more detail elsewhere herein.

Referring now to step 705, based on the probabilistic confidence indicator, an entity may be associated with the financial transaction and/or the NLP output in the entity identification database. More particularly, in one or more embodiments, the entity service may generate a probabilistic confidence indicator for one of the entities on the list of entities which exceeds the pre-determined threshold for standardized entity identification and, accordingly, will associate the transaction and/or the feed-forward string(s) and/or data (e.g., output from the NLP, lookup table(s), and/or FIDI feed) with the entity in the entity ID database.

Step 705 may be executed by one or both of a computing device and a server. In one or more embodiments, step 705 is executed by the server operated by the financial service provider providing the open banking platform including the entity service.

The updated data and string(s) for the entity in the entity ID database may automatically be incorporated into the upstream lookup table and/or used to retrain the NLP for use in connection with identifying entities in future financial transactions. For example, a string having a given data type which is heavily weighted for distinguishability between entities relative to other possible string(s) and/or string type(s), and that is associated with the entity according to the standardized entity identification described above, may be mapped as a new token mapping to the identified entity and/or its unique identifier(s) in the lookup table. Future analyses by the lookup table on future transactions may search for exact or approximate matches to such string(s) and affirmatively identify the entity based thereon, e.g., without the need for repeated probabilistic analyses within the entity service. Accordingly, probabilistic analyses by the entity service help evolve the deterministic capabilities of upstream lookup table and other components, progressively and automatically increasing the efficiency and operation of the entity identification system.

In another example, the lookup table may be reconfigured or retrained based on the failure of certain string(s) to lead to a standardized entity identification. More particularly, where a string is found and identified but is ultimately insufficient to push the probabilistic confidence indicator high enough to match the threshold for standardized matching, the string and/or its corresponding type may be deemphasized and/or the manner by which it is captured and/or analyzed may be altered in future implementations of the lookup table.

For another example, the NLP may be reconfigured based on the matching and/or identifying string(s) (e.g., the NLP output) which contribute to the standardized entity identification. The reconfigured NLP may more adeptly look for and produce output focused on such string(s) in connection with future transactions. Also or alternatively, such a reconfigured NLP may prioritize the same or similar string type(s) in producing output for the entity service in connection with future transactions, for example where those string types were observed as having favorable characteristics with respect to distinguishing entities from one another.

In another example, the NLP may be reconfigured or retrained based on the failure of certain string(s) to lead to a standardized entity identification. More particularly, where a string is found and identified but is insufficient to push the probabilistic confidence indicator high enough to match the threshold for standardized matching, the string and/or its corresponding type may be deemphasized and/or its weighting may be reduced by reconfiguration and/or retraining of the NLP.

The method may include additional, less, or alternate steps and/or device(s), including those discussed elsewhere herein. For example, in one or more embodiments, the entity service will generate the list of one or more entity (ies) and/or the corresponding probabilistic confidence indicator(s) based on additional feed-backward data. In one or more embodiments, feed-backward input from an RFM processor and/or a customer edit or input module may additionally be incorporated into the analysis (e.g., distance metric(s)) implemented by the entity service for generation of the list of one or more entity (ies) and/or the corresponding probabilistic confidence indicator(s), in each case as discussed in more detail below.

In addition, it should be noted that classification and identification processes for a single financial transaction performed by embodiments of the present system may be repeated or otherwise performed in parallel several times, respectively in connection with identifying entities performing different roles and/or serving in different capacities in the transaction. For example, one set of entity service operational parameters, rules, and/or the like may be applicable to standardized identification of an entity filling one role in connection with a transaction (e.g., acquirer), whereas a different set of entity service operational parameters, rules, and/or the like may be applicable to standardized identification of the same or another entity filling a different role in connection with a transaction (e.g., a payment processing network). Accordingly, a separate analysis may be performed for each role in question without departing from the spirit of the present invention.

Moreover, one or more output(s) may be generated based on the standardized entity identification for the present financial transaction. For example, in one or more embodiments, a partner requirements database may be accessed, defining the preferred and/or required elements of any output of the standardized entity identification system and/or methods. An output module may access the requirements database, access one or more additional data sources (e.g., the merchant database and/or entity ID database) to acquire the required and/or preferred data defined in the requirements database, and configure one or more output(s) (e.g., report(s) and/or new database entries) to include the required and/or preferred data.

### Exemplary Computer-Implemented Method for Feed-Forward, Feed-Backward Entity Standardization

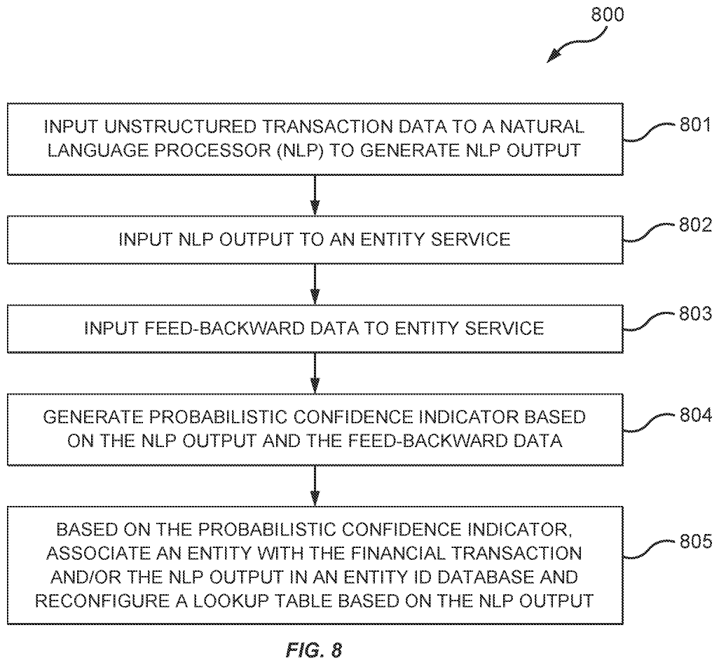

FIG. 8 depicts a flowchart including a listing of steps of an exemplary computer-implemented method 800 for feed-forward, feed-backward entity standardization. The steps may be performed in the order shown in FIG. 8, or they may be performed in a different order. Furthermore, some steps may be performed concurrently as opposed to sequentially. In addition, some steps may be optional.

The computer-implemented method 800 is described below, for ease of reference, as being executed by exemplary devices and components introduced with the embodiments illustrated in FIGS. 1-4. For example, the steps of the computer-implemented method 800 may be performed by the computer(s) 12, the server(s) 14, the APIs 16, and the network(s) 18, 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention and, in many embodiments, will be performed by a single computing device or server. One or more computer-readable medium(s) may also be provided. The computer-readable medium(s) may include one or more executable programs stored thereon, wherein the program(s) instruct one or more processing elements to perform all or certain of the steps outlined herein. The program(s) stored on the computer-readable medium(s) may instruct the processing element(s) to perform additional, fewer, or alternative actions, including those discussed elsewhere herein.

Referring to step 801, unstructured transaction data corresponding to a financial transaction may be input to a natural language processor (NLP) to generate NLP output comprising a portion of the unstructured transaction data. Step 801 may be executed by one or both of a computing device and a server. In one or more embodiments, step 801 is executed by a server operated by a financial service provider providing an open banking platform including an entity service for probabilistic standardized entity identification.

The unstructured transaction data may be obtained, and the inputting step may be performed, periodically, continuously, and/or upon request from a variety of sources. For example, unstructured transaction data may be obtained from an API periodically and/or in batches, in real-time during processing of the financial transaction, or otherwise without departing from the spirit of the present invention. In one or more embodiments, an automated data acquisition process may cause intermittent batch downloads of unstructured transaction data from APIs associated with financial institutions, financial service providers, and/or third-party databases storing such data.

In addition, the NLP may take as input output(s) from an upstream lookup table, as discussed in more detail above. For example, the output(s) from the upstream lookup table may comprise the results of distance metric and other analyses performed by the lookup table in an attempt to provide deterministic standardized entity identification, and together with those portion(s) of the unstructured transaction data on which such analyses are based, may be taken as input to the NLP.

As discussed in more detail above, the NLP output may comprise portion(s) of the unstructured transaction data and/or lookup table output identified by the NLP as having potential entity-identification meaning for downstream probabilistic analyses of an entity. The NLP may comprise deep learning model(s), such as a named entity recognition (NER) model and/or a masked language model (MLM). The NLP may be constituted and may operate substantially in the manner described in connection with the exemplary system and any of method(s) 500, 600, and/or 700 above, except wherever described otherwise and/or supplemented in connection with method 800.

Referring to step 802, the NLP output may be input to the entity service. As discussed above, the NLP output may comprise strings and combinations of strings, extracted from the unstructured transaction data and/or output from the lookup table, which may be used to identify one or more entities involved in the financial transaction.

Step 802 may be executed by one or both of a computing device and a server. In one or more embodiments, step 802 is executed by a server operated by a financial service provider providing an open banking platform including an entity service for probabilistic standardized entity identification.

Referring to step 803, feed-backward entity data may also be inputted to the entity service. Step 803 may be executed by one or both of a computing device and a server. In one or more embodiments, step 803 is executed by a server operated by the financial service provider providing the open banking platform including an entity service for probabilistic standardized entity identification. Also or alternatively, the feed-backward entity data may be curated, managed, and/or generated by the server operated by the financial service provider providing the open banking platform including the entity service.

As discussed in more detail above, the feed-backward entity data may be partly or entirely sourced outside of transaction records generated in connection with the transaction records corresponding to the financial transaction under analysis. For example, the feed-backward entity data may comprise one or more of the following, in each case discussed in more detail in preceding sections: merchant data and metadata stored in a merchant database; input from an RFM processor, including recurring transaction indicator(s); and/or account holder input generated via a customer edit or input module. Such feed-backward entity data may be generated, consumed, and incorporated into entity service computations substantially in the manners described in connection with the exemplary system and any of method(s) 500, 600, and/or 700 above, except wherever described otherwise and/or supplemented in connection with method 800.

One of ordinary skill will appreciate that other types of feed-backward entity data may be incorporated into the computations and/or analyses of the entity service within the scope of the present invention.

Referring to step 804, the entity service may generate a probabilistic confidence indicator based on the NLP output and the feed-backward data. The entity service may be constituted and may operate substantially in the manner described in connection with any of the exemplary system and methods 500, 600, and/or 700 above, except wherever described otherwise and/or supplemented in connection with method 800.

Step 804 may be executed by one or both of a computing device and a server. In one or more embodiments, step 804 is executed by the server operated by the financial service provider providing the open banking platform including the entity service.

In one or more embodiments, the probabilistic confidence indicator may meet or exceed a threshold for standardized matching of an entity to the financial transaction. For example, in one or more embodiments, feed-backward data are analyzed by the entity service to generate the list of entity (ies) and corresponding probabilistic indicator(s). For example, analysis by the entity service of feed-forward strings from the NLP and/or lookup table(s) (and, optionally, of a FIDI feed) may result in a probabilistic confidence indicator below a threshold required for standardized entity identification uniquely identifying an entity at a required level of resolution. The threshold may be a pre-determined distance threshold of the distance metric(s) implemented by the entity service. However, the feed-backward data may move the probabilistic confidence indicator over the threshold and permit standardized entity identification.

In one or more embodiments, the threshold for standardized entity identification may not be met. Accordingly, the entity service may—rather than concluding with a standardized entity identification—instead merely identify a suggested or most likely entity from among the list of entities (or a new entity identification may be generated, for example if none of the listed entities match sufficiently to reach a likely or suggested status).

Wherever a new entity identification is generated, one or more strings analyzed by the entity service according to the description above may be automatically added to the data and metadata stored regarding the new entity in the entity service and/or entity ID database. Whether a particular analyzed string is added to the entry associated with the new entity may depend, for example, on a template for new entity creation, which treats certain data and strings analyzed by the entity service from the feed-forward input and certain of the feed-backward input as being inherently distinctive and/or distinguishing in the first instance. However, such template(s) and/or corresponding new entity data and/or metadata may be revised based on learning within the system, described in more detail elsewhere herein.

Referring now to step 805, based on the probabilistic confidence indicator, an entity may be associated with the financial transaction and/or the NLP output in the entity identification database, and a lookup table may be reconfigured based on the NLP output. Step 805 may be executed by one or both of a computing device and a server. In one or more embodiments, step 805 is executed by the server operated by the financial service provider providing the open banking platform including the entity service.

In one or more embodiments, the entity service may generate a probabilistic confidence indicator for one of the entities on the list of entities which exceeds the pre-determined threshold for standardized entity identification and, accordingly, will associate the transaction and/or the feed-forward string(s) and/or data (e.g., output from the NLP, lookup table(s), and/or FIDI feed) with the entity in the entity ID database.

The updated data and string(s) for the entity in the entity ID database may automatically be incorporated into the upstream lookup table and/or used to retrain the NLP for use in connection with identifying entities in future financial transactions. For example, a string having a given data type which is heavily weighted for distinguishability between entities relative to other possible string(s) and/or string type(s), and that is associated with the entity according to the standardized entity identification described above, may be mapped as a new token mapping to the identified entity and/or its unique identifier(s) in the lookup table. Future analyses by the lookup table on future transactions may search for exact or approximate matches to such string(s) and affirmatively identify the entity based thereon, e.g., without the need for repeated probabilistic analyses within the entity service.

Accordingly, probabilistic analyses by the entity service help evolve the deterministic capabilities of upstream lookup table and other components, progressively and automatically increasing the efficiency and operation of the entity identification system. In another example, the lookup table may be reconfigured or retrained based on the failure of certain string(s) to lead to a standardized entity identification. More particularly, where a string is found and identified but is ultimately insufficient to push the probabilistic confidence indicator high enough to match the threshold for standardized matching, the string and/or its corresponding type may be deemphasized and/or the manner by which it is captured and/or analyzed may be altered in future implementations of the lookup table.

For another example, the NLP may be reconfigured based on the matching and/or identifying string(s) (e.g., the NLP output) which contribute to the standardized entity identification. The reconfigured NLP may more adeptly look for and produce output focused on such string(s) in connection with future transactions. Also or alternatively, such a reconfigured NLP may prioritize the same or similar string type(s) in producing output for the entity service in connection with future transactions, for example where those string types were observed as having favorable characteristics with respect to distinguishing entities from one another.

In another example, the NLP may be reconfigured or retrained based on the failure of certain string(s) to lead to a standardized entity identification. More particularly, where a string is found and identified but is insufficient to push the probabilistic confidence indicator high enough to match the threshold for standardized matching, the string and/or its corresponding type may be deemphasized and/or its weighting may be reduced by reconfiguration and/or retraining of the NLP.

The method may include additional, less, or alternate steps and/or device(s), including those discussed elsewhere herein. For example, it should be noted that classification and identification processes for a single financial transaction performed by embodiments of the present system may be repeated or otherwise performed in parallel several times, respectively in connection with identifying entities performing different roles and/or serving in different capacities in the transaction. In one or more embodiments, one set of entity service operational parameters, rules, and/or the like may be applicable to standardized identification of an entity filling one role in connection with a transaction (e.g., acquirer), whereas a different set of entity service operational parameters, rules, and/or the like may be applicable to standardized identification of the same or another entity filling a different role in connection with a transaction (e.g., a payment processing network). Accordingly, a separate analysis may be performed for each role in question without departing from the spirit of the present invention.

Moreover, one or more output(s) may be generated based on the standardized entity identification for the present financial transaction. For example, in one or more embodiments, a partner requirements database may be accessed, defining the preferred and/or required elements of any output of the standardized entity identification system and/or methods. An output module may access the requirements database, access one or more additional data sources (e.g., the merchant database and/or entity ID database) to acquire the required and/or preferred data defined in the requirements database, and configure one or more output(s) (e.g., report(s) and/or new database entries) to include the required and/or preferred data.

### Additional Considerations

In this description, references to “one embodiment”, “an embodiment”, or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as transceiver elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. A computer-implemented method for entity standardization comprising, via one or more transceivers and/or processors:
inputting unstructured transaction data corresponding to a financial transaction to a natural language processor (NLP) to generate NLP output comprising a portion of the unstructured transaction data;
inputting the NLP output to an entity service;
inputting entity feedback data to the entity service;
based on the NLP output and the entity feedback data, generating a probabilistic confidence indicator via the entity service, the probabilistic confidence indicator meeting or exceeding a threshold for standardized matching of an entity to the financial transaction; and
based on the probabilistic confidence indicator: (i) associating the entity with one or more of the financial transaction and the NLP output in an entity identification database, and (ii) configuring a lookup table to deterministically identify the entity in connection with a second financial transaction based on the NLP output.

2. The computer-implemented method of claim 1, wherein the NLP output is associated with the entity in the entity identification database.

3. The computer-implemented method of claim 2, further comprising, based on the probabilistic confidence indicator and via the one or more transceivers and/or processors, retraining the NLP using the NLP output for generation of additional NLP output corresponding to a third financial transaction.

4. The computer-implemented method of claim 1, wherein the entity feedback data comprises a recurring transaction indicator for whether the financial transaction is part of an installment payment plan.

5. The computer-implemented method of claim 1, wherein the entity feedback data comprises input from an account holder corresponding to the financial transaction, the input from the account holder relating the entity to one or both of the NLP output and the financial transaction.

6. The computer-implemented method of claim 1, wherein the entity feedback data comprises merchant metadata for a plurality of merchants, the plurality of merchants including the entity.

7. The computer-implemented method of claim 1, wherein the entity is a merchant, further comprising analyzing, via the one or more transceivers and/or processors, the entity feedback data to identify a pattern of behavior of the merchant and adjusting the probabilistic confidence indicator by increasing confidence with respect to the merchant based on the pattern.

8. A system for entity standardization, the system comprising one or more processors individually or collectively programmed to:
input unstructured transaction data corresponding to a financial transaction to a natural language processor (NLP) to generate NLP output comprising a portion of the unstructured transaction data;
input the NLP output to an entity service;
input entity feedback data to the entity service;
based on the NLP output and the entity feedback data, generate a probabilistic confidence indicator via the entity service, the probabilistic confidence indicator meeting or exceeding a threshold for standardized matching of an entity to the financial transaction; and
based on the probabilistic confidence indicator: (i) associate the entity with one or more of the financial transaction and the NLP output in an entity identification database, and (ii) configure a lookup table to deterministically identify the entity in connection with a second financial transaction based on the NLP output.

9. The system of claim 8, wherein the NLP output is associated with the entity in the entity identification database.

10. The system of claim 9, the one or more processors being further individually or collectively programmed to, based on the probabilistic confidence indicator, retrain the NLP using the NLP output for generation of additional NLP output corresponding to a third financial transaction.

11. The system of claim 8, wherein the entity feedback data comprises a recurring transaction indicator for whether the financial transaction is part of an installment payment plan.

12. The system of claim 8, wherein the entity feedback data comprises input from an account holder corresponding to the financial transaction, the input from the account holder relating the entity to one or both of the NLP output and the financial transaction.

13. The system of claim 8, wherein the entity feedback data comprises merchant metadata for a plurality of merchants, the plurality of merchants including the entity.

14. The system of claim 8, wherein the entity is a merchant and the one or more processors are further individually or collectively programmed to analyze the entity feedback data to identify a pattern of behavior of the merchant and adjust the probabilistic confidence indicator by increasing confidence with respect to the merchant based on the pattern.

15. A non-transitory computer-readable storage media having computer-executable instructions for entity standardization stored thereon, wherein when executed by at least one processor the computer-executable instructions cause the at least one processor to:
input unstructured transaction data corresponding to a financial transaction to a natural language processor (NLP) to generate NLP output comprising a portion of the unstructured transaction data;
input the NLP output to an entity service;
input entity feedback data to the entity service;
based on the NLP output and the entity feedback data, generate a probabilistic confidence indicator via the entity service, the probabilistic confidence indicator meeting or exceeding a threshold for standardized matching of an entity to the financial transaction; and
based on the probabilistic confidence indicator: (i) associate the entity with one or more of the financial transaction and the NLP output in an entity identification database, and (ii) configure a lookup table to deterministically identify the entity in connection with a second financial transaction based on the NLP output.

16. The non-transitory computer-readable storage media of claim 15, wherein the NLP output is associated with the entity in the entity identification database.

17. The non-transitory computer-readable storage media of claim 16, wherein when executed by the at least one processor the computer-executable instructions further cause the at least one processor to, based on the probabilistic confidence indicator, retrain the NLP using the NLP output for generation of additional NLP output corresponding to a third financial transaction.

18. The non-transitory computer-readable storage media of claim 15, wherein the entity feedback data comprises a recurring transaction indicator for whether the financial transaction is part of an installment payment plan.

19. The non-transitory computer-readable storage media of claim 15, wherein the entity feedback data comprises input from an account holder corresponding to the financial transaction, the input from the account holder relating the entity to one or both of the NLP output and the financial transaction.

20. The non-transitory computer-readable storage media of claim 15, wherein the entity feedback data comprises merchant metadata for a plurality of merchants, the plurality of merchants including the entity.
